(19) United States
(12) Patent Application Publication
(10) Pub. No.: US 2008/0059126 A1
(43) Pub. Date: Mar. 6, 2008

(54) SYSTEM AND METHOD FOR MEASURING STRAIGHTNESS OF A LINE BUILT BASED ON POINT CLOUD

(75) Inventors: CHIH-KUANG CHANG, Tu-Cheng (TW); XIAO-CHAO SUN, Shenzhen (CN); DONG-HAI LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/611,153

(22) Filed: Dec. 15, 2006

(30) Foreign Application Priority Data
Aug. 29, 2006 (CN) 200610200832.3

(51) Int. Cl. G06F 17/17; G06F 17/40

(52) U.S. Cl. 702/189; 702/127; 702/179; 702/187

(57) ABSTRACT

A computer-based method for measuring straightness of a line built based on point cloud data is provided. The method includes the steps of: receiving point cloud data; receiving parameters set by a user; computing an equation of a line based on the point cloud data; computing a residual value of each point in the point cloud; computing a straightness of the line; constructing a connected points line based on the points in the point cloud; and simulating a cloud point simulation based on the point cloud data, the line, the residual value of each point, and the connected points line. A related system is also provided.

### BACKGROUND OF THE INVENTION

1. Field of the Invention

The present invention generally relates to systems and methods for measuring errors, and more particularly to a system and method for measuring straightness of a line.

2. Description of Related Art

Straightness measurement is commonly used in the precision measurement field. Conventional straightness reports are data report forms as shown by FIG. 1. In FIG. 1, the straightness report only shows coordinates of points. The data report is not very visual, real position of each point may not be shown clearly, and straightness and tolerance of the line need to be translated by a professional, a process that is hard for laypeople.

What is needed, therefore, is a system and a method for measuring straightness, which can simulate a cloud point simulation based on quantized data, making analysis of straightness more visualized and clearly.

### SUMMARY OF THE INVENTION

A system for measuring straightness of a line built based on point cloud is provided. The system comprises: a receiving module configured for receiving point cloud data and parameters set by a user; a computing module configured for computing an equation of a line, computing a straightness of the line, and computing a residual value of each point in the point cloud based on the point cloud data; a constructing module configured for constructing a connected points line based on the points in the point cloud; and a simulating module for simulating a cloud point simulation based on the point cloud data, the line, the residual value of each point, and the connected points line.

A computer-based method for measuring straightness of a line built based on point cloud is provided. The method includes the steps of: receiving point cloud data; receiving parameters set by a user; computing an equation of a line based on the point cloud data; computing a residual value of each point in the point cloud; computing a straightness of the line; constructing a connected points line based on the points in the point cloud; and simulating a cloud point simulation based on the point cloud data, the line, the residual value of each point, and the connected points line.

Other systems, methods, features, and advantages of the present invention will be or become apparent to one with skill in the art on examination of the following drawings and detailed description.

### BRIEF DESCRIPTION OF THE DRAWINGS

FIG. 1 is a schematic diagram illustrating a conventional straightness report.

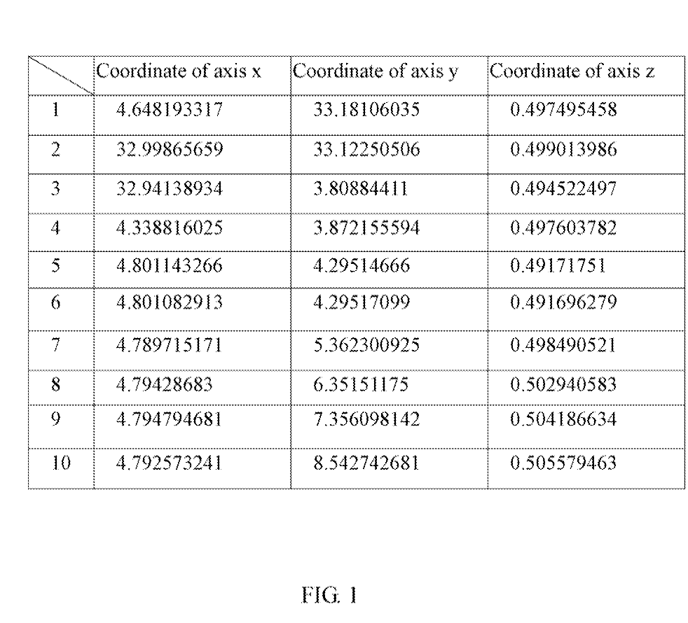

FIG. 2 is a schematic diagram illustrating hardware configuration of a system for measuring straightness of a line built based on point cloud in accordance with a preferred embodiment;

FIG. 3 is a schematic diagram illustrating function modules of an application server of FIG. 1;

FIG. 4 is a flowchart illustrating a method for measuring straightness of a line built based on point cloud in accordance with a preferred embodiment;

FIG. 5 is a schematic diagram illustrating cloud point simulation of a 2-dimensional line; and

FIG. 6 is a schematic diagram illustrating cloud point simulation of a 3-dimensional line.

### DETAILED DESCRIPTION OF THE INVENTION

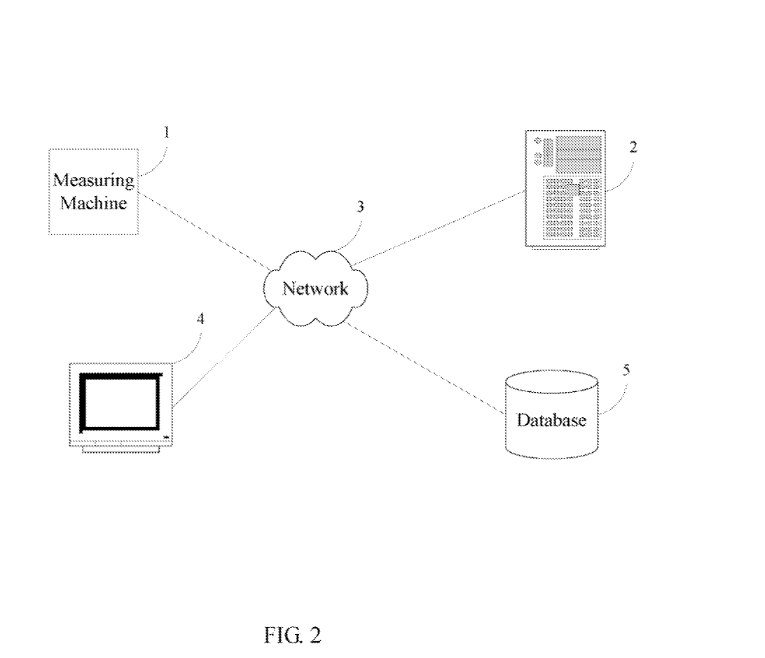

FIG. 2 is a schematic diagram illustrating hardware configuration of a system for measuring straightness of a line built based on point cloud (hereinafter, “the system”), in accordance with a preferred embodiment. The system typically includes a measuring machine 1, an application server 2, a network 3, a plurality of application terminals 4 (only one shown), and a database 5.

The measuring machine 1 is configured for scanning a physical object, for obtaining a set of points (hereinafter “point cloud”). Each of the point in the set of points contains n-dimensional coordinates data (hereinafter “point cloud data”) corresponding to the point.

The database 5 electronically connects with the measuring machine 1 via the network 3, and is configured for saving the point cloud data.

The network 3 is an electronic network, which may be the Internet, an Intranet, or any other suitable type of communications link.

The application terminals 4 are electronically connected with the application server 2, and may be located at various internal departments of an organization that implements the system. The application server 2 is accessible via any one of the application terminals 4 provided in the organization to obtain results of a processed point cloud data.

The application server 2 includes a plurality of function modules mainly configured for processing the point cloud data thereby yielding processed point cloud data and simulating a cloud point simulation based on the point cloud data.

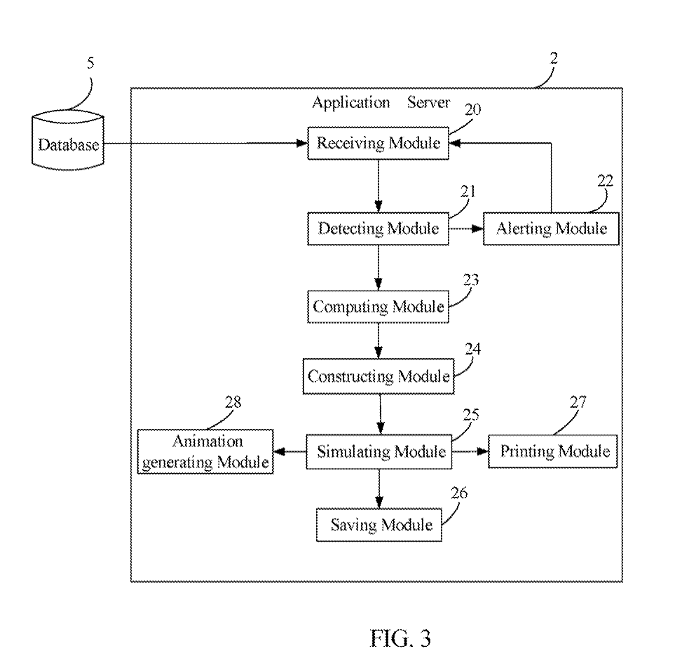

FIG. 3 is a schematic diagram illustrating function modules of the application server 2. The application server 2 mainly includes a receiving module 20, an detecting module 21, an alerting module 22, a computing module 23, a constructing module 24, and a simulating module 25.

The receiving module 20 is configured for receiving the point cloud data that may be from the database 5. The receiving module 20 is also configured for receiving parameters set by a user, the parameters may be, allowable tolerance, point size, and so on.

The detecting module 21 is configured for detecting whether the parameters set by the user are valid. The alerting module 22 is configured for notifying the user when any of the parameters are not valid.

The computing module 23 is configured for computing an equation of a least squares line based on the point cloud data using the least squares method. The computing module 23 is also configured for computing the residual value of each point of the point cloud. The residual value of each point is a difference between the each point to the least squares line. Furthermore, the computing module 23 is configured for computing the straightness of the least squares line.

The constructing module 24 is configured for constructing a connected points line. The connected points line is a curved line that is formed by using a smooth line to connect the points of the point cloud.

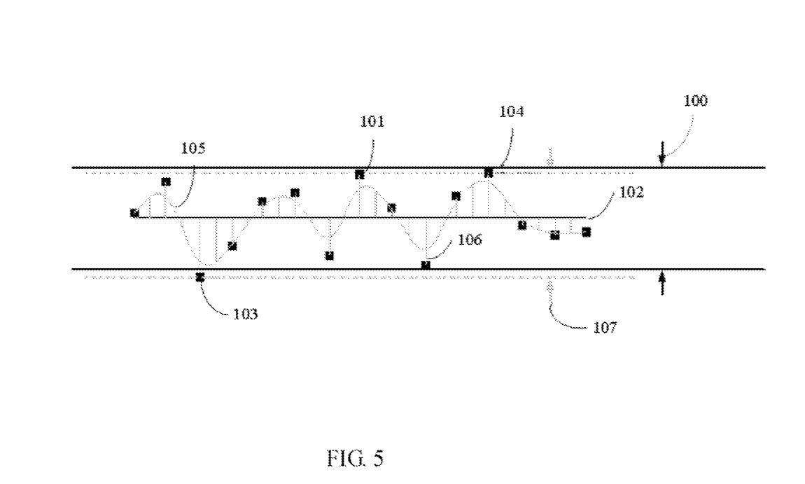

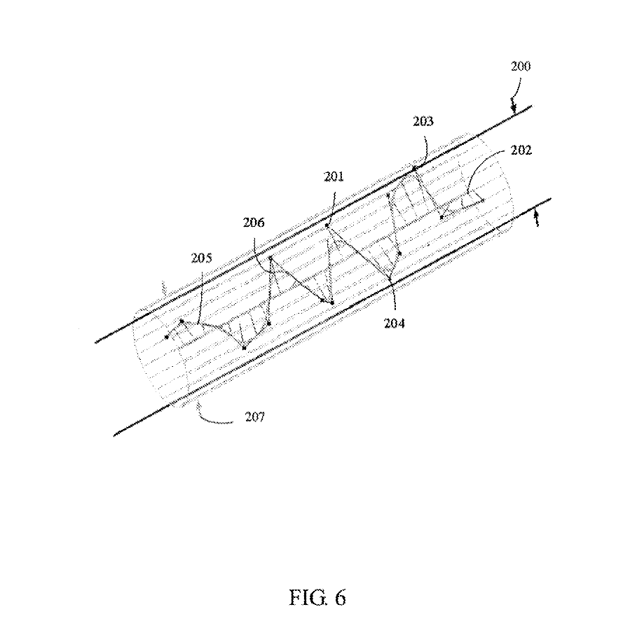

The simulating module 25 is configured for simulating a cloud point simulation by utilizing the point cloud data, the least squares line, the residual value of each point, and the connected points line. The cloud point simulation is shown in FIG. 5 or FIG. 6.

Furthermore, the system also may include a saving module 26 configured for saving the cloud point simulation; a printing module 27 configured for printing the cloud point simulation; and an animation generating module 28 configured for generating the cloud point simulation animation.

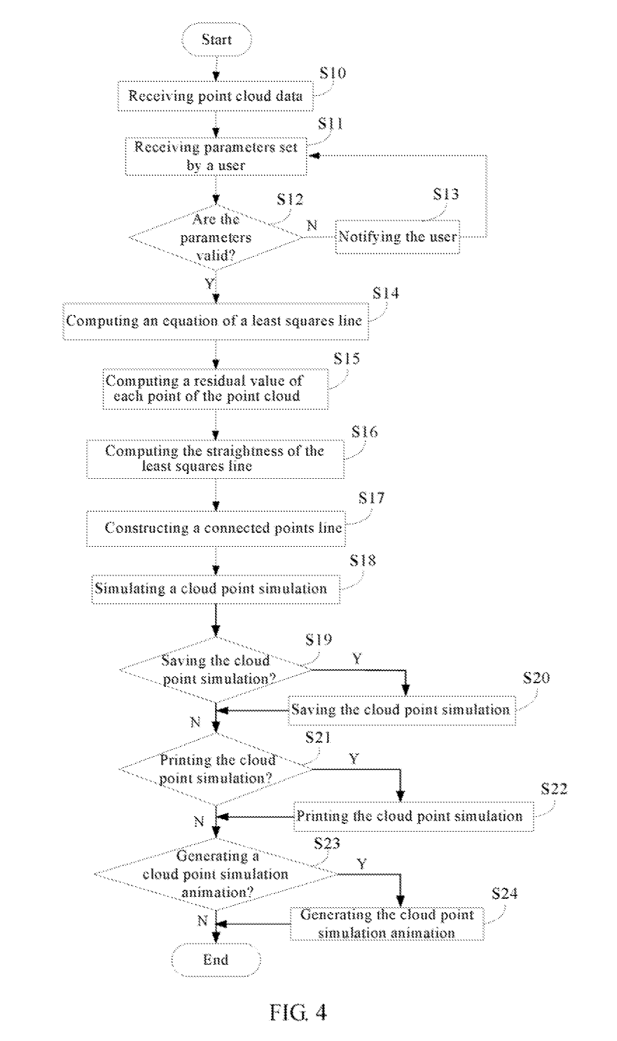

FIG. 4 is a flowchart illustrating a method for measuring straightness of a line built based on point cloud in accordance with a preferred embodiment.

In step S10, the receiving module 20 receives point cloud data that may be from the database 5.

In step S11, the receiving module 20 receives parameters set by the user. The parameters may include an allowable tolerance, point size, and so on.

In step S12, the detecting module 21 detects whether the parameters are valid, namely detecting whether the parameters meets a predetermined criteria correspondingly.

If any of the parameters are not valid, in step S13, the alerting module 22 notifies the user that the parameter is not valid, and the procedure returns to step S11.

If all the parameters are valid, in step S14, the computing module 23 computes an equation of a least squares line derived based on the point cloud data using the least squares method.

In step S15, the computing module 23 further computes the residual value of each point of the point cloud to the least squares line.

In step S16, the computing module 23 further computes the straightness of the least squares line. If the least squares line is derived from 2-dimensional coordinate data of the points, the straightness is the sum of the largest residual values of two points on the upper bound and the lower bound of the least squares line. In another example, if the least squares line is derived from 3-dimensional coordinate data of the points, the straightness is the biggest residual value multiplied by 2.

In step S17, the constructing module 24 constructs the connected points line.

In step S18, the figure simulating module 25 simulates a cloud point simulation based on the point cloud data, the least squares line, the residual value of each point, and the connected points line.

In step S19, the detecting module 21 detects if the user wishes to save the cloud point simulation. If the user wishes to save the cloud point simulation, in step S20, the saving module 26 saves the cloud point simulation. In step S21, the detecting module 21 detects if the user wishes to print the cloud point simulation. If the user wishes to print the cloud point simulation, in step S22, the printing module 27 prints the cloud point simulation. In step S23, the detecting module 21 detects if the user wishes to generate a cloud point simulation animation. If the user wishes to generate the cloud point simulation animation, the animation generating module 28 generates the cloud point simulation animation.

FIG. 5 is a schematic diagram illustrating a cloud point simulation of a least squares line derived from 2-dimensional coordinates data of points. In FIG. 5, 100 shows the allowable tolerance set by the user; 101 shows a point in the 2-dimensional point cloud; 102 shows the least squares line derived based on the 2-dimensional point cloud; 103 and 104 distributes on the upper bound and the lower bound of the least squares line, which shows a valley point and a peak point separately; 105 shows the connected points line; 106 shows a residual value of a point in the point cloud; and 107 shows the straightness of the least squares line.

FIG. 6 is a schematic diagram illustrating a cloud point simulation of a least squares line derived from 3-dimensional coordinates data of the points. FIG. 9 is similar to FIG. 8, in which, 200 shows the allowable tolerance set by the user; 201 shows a point in the 3-dimensional point cloud; 202 shows the least squares line derived based on the 3-dimensional point cloud; 203 and 204 distributes on the upper bound and the lower bound of the least squares line, which shows a valley point and a peak point separately; 205 shows the connected points line; 206 shows a residual value of a point in the point cloud; and 207 shows the straightness of the least squares linear graph.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for measuring straightness of a line built based on point cloud comprising:
a receiving module configured for receiving point cloud data and parameters set by a user;
a computing module configured for computing an equation of a line, computing a straightness of the line, and computing a residual value of each point in the point cloud based on the point cloud data;
a constructing module configured for constructing a connected points line based on the points in the point cloud; and
a simulating module for simulating a cloud point simulation based on the point cloud data, the line, the residual value of each point, and the connected points line.

2. The system according to claim 1, further comprising:
a detecting module configured for detecting whether the parameters are valid;
an alerting module configured for notifying the user when anyone of the parameter is not valid;

3. The system according to claim 1, wherein the parameters set by a user comprise: allowable tolerance and point size.

4. The system according to claim 1, further comprising:
a saving module configured for saving the cloud point simulation;
a printing module configured for printing the cloud point simulation; and
an animation generating module configured for generating the cloud point simulation animation.

5. A computer-based method for measuring straightness of a line built based on point cloud, the method comprising the steps of:
receiving point cloud data;
receiving parameters set by a user;
computing an equation of a line based on the point cloud data;
computing a residual value of each point in the point cloud;
computing a straightness of the line;
constructing a connected points line based on the points in the point cloud; and
simulating a cloud point simulation based on the point cloud data, the line, the residual value of each point, and the connected points line.

6. The method according to claim 5, further comprising:
detecting whether the parameters set by the user are valid; and
alerting the user if any parameter is not valid.

7. The method according to claim 5, wherein the parameters comprise: allowable tolerance and point size.

8. The method according to claim 5, further comprising: saving the cloud point simulation, printing the cloud point simulation and/or generating the cloud point simulation animation.
